(19) United States
(12) Patent Application Publication
(10) Pub. No.: US 2025/0042273 A1
(43) Pub. Date: Feb. 6, 2025

(54) CHARGING SYSTEM FOR NON-ROAD ELECTRIC VEHICLE

(71) Applicant: Caterpillar Inc., Peoria, IL (US)

(72) Inventors: Dachuan Yu, Dunlap, IL (US); Dustin Craig Selvey, Eureka, IL (US); Suresh Baddam Reddy, Peoria, IL (US)

(73) Assignee: Caterpillar Inc., Peoria, IL (US)

(21) Appl. No.: 18/228,908

(22) Filed: Aug. 1, 2023

(51) Int. Cl. B60L 53/16; H02J 7/00

(52) U.S. Cl. CPC B60L 53/16; H02J 7/0013; B60L 2200/40; B60L 2210/10; B60L 2210/30; B60L 2210/40; H02J 2207/20

(57) ABSTRACT

A portable charging system for an off-road electric vehicle includes a line connection port; a first Alternating Current to Direct Current (AC-to-DC) converter circuit connected to the line connection port, wherein the first AC-to-DC converter circuit is a bidirectional AC-to-DC converter circuit; and a three-port triple active bridge (TAB) converter circuit including a DC line port coupled to the first AC-to-DC converter circuit, a DC charging port, and a DC energy storage port.

### TECHNICAL FIELD

This document relates to electric powered work machines and in particular to a portable Megawatt class portable charging system for field charging of electric work machines.

### BACKGROUND

Powering a large moving work machine (e.g., a wheel loader, a mining truck, etc.) with an electric motor requires a large mobile electric energy source that can provide current of tens to hundreds of Amperes (Amps). A job site where large electric work machines operate can often be a remote location where the electrical infrastructure for charging the work machines is either very limited or non-existent. Thus, it is desired that an energy storage system (ESS) and distributed energy resources (DERs) be integrated with a charging station at the job site to reduce or eliminate reliance on grid capacity to charge electric work machines. However, current solutions for remote charging stations are bulky and expensive, and also suffer from high electrical energy losses due to multiple transformers and power stages included in the charging stations.

### SUMMARY OF THE INVENTION

Electric powered large moving work machines use large capacity battery systems that need charging. It is desired to provide charging at a remote job site using a portable system that minimizes cost of operation and minimizes energy losses due to charging.

An example portable charging system for an off-road electric vehicle includes a line connection port: a bidirectional Alternating Current to Direct Current (AC-to-DC) converter circuit connected to the line connection port, and a three-port triple active bridge (TAB) converter circuit connected to the bidirectional AC-to-DC converter circuit. The TAB converter circuit includes three ports including a DC line port coupled to the bidirectional AC-to-DC converter circuit, a DC charging port, and a DC energy storage port.

An example method of operating a portable charging system for a non-road electric work machine includes operating the charging system in a first power-flow state in which power flows from a line connection port of the charging system to a charging connection port of the charging system, operating the charging system in a second power-flow state in which power flows from the line connection port of the charging system to an energy storage connection port of the charging system, and operating the charging system in a third power-flow state in which power flows from the energy storage connection port of the charging system to the line connection port of the charging system.

### BRIEF DESCRIPTION OF THE DRAWINGS

FIG. 1 is an elevation view depicting an example work machine in accordance with this disclosure.

FIG. 2 is a diagram of a megawatt-class portable charging system for a work machine and an environment in which it operates in accordance with this disclosure.

FIG. 3 is another diagram of a megawatt-class portable charging system for a work machine and an environment in which it operates in accordance with this disclosure.

FIG. 4 is a circuit diagram of an example of a triple-active-bridge converter circuit in accordance with this disclosure.

FIG. 5 is a flow diagram of an example of a method of operating a portable charging system in accordance with this disclosure.

### DETAILED DESCRIPTION

Examples according to this disclosure are directed to methods and devices that improve efficiency of the electric motors of a work machine.

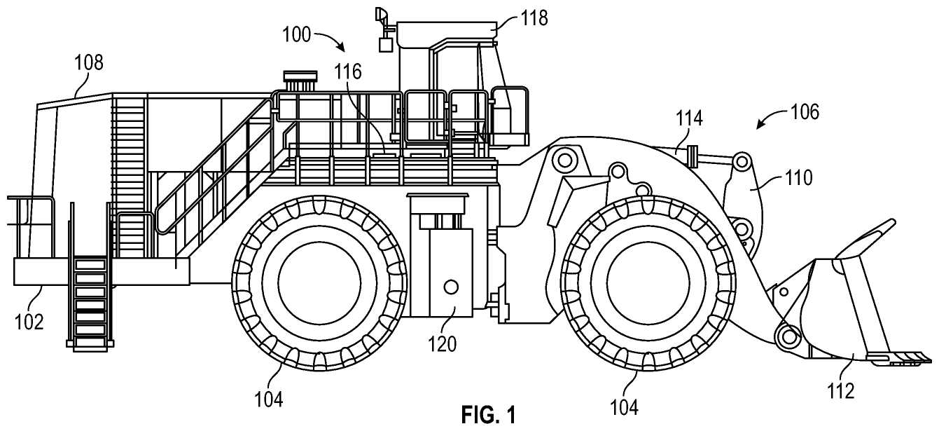

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the work machine 100.

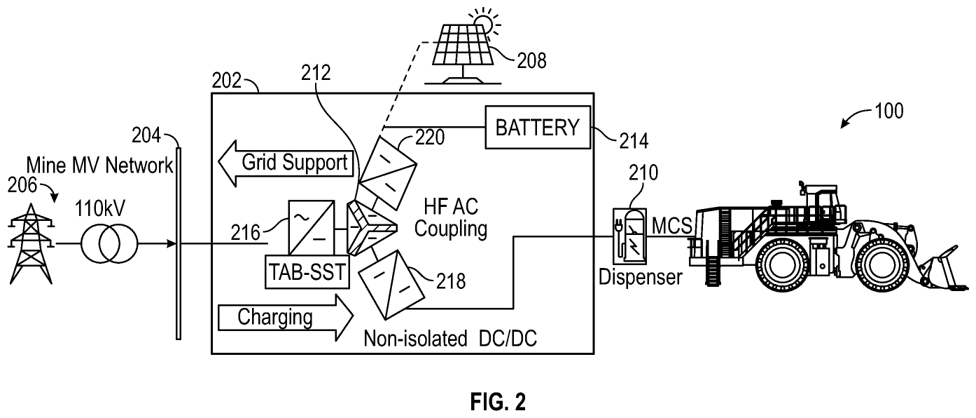

FIG. 2 is a diagram of a megawatt-class portable charging system 202 for a non-road work machine and an environment in which it operates. The input to the portable charging system 202 can be the medium voltage network 204 of the mine or other remote job site referred to herein as the line connection port. The medium voltage network 204 may be derived from the electric utility grid 206 and may be a 35 kilovolt (35 kV), 13.8 kV, or 6.6 kV line for example. The input may also be from distributed energy resources (DERs) 208 such as on-site solar panels, other photovoltaic sources, wind energy resources, etc. The output of the portable charging system 202 is a charging connection port that may be coupled to a megawatt (MW) charging standard (MCS) dispenser unit 210. The portable charging system may be housed in an International Organization for Standardization (ISO) container or shipping container. The dispenser unit 210 may located away from the portable charging system 202 to be positioned near the work machine 100. The charging connection port of the portable charging system 202 can be connected to the dispenser unit 210 by MCS cables and an MCS plug or connector.

The portable charging system 202 includes an integrated energy storage subsystem 214 that includes one or more batteries or other renewable energy source. The portable charging system 202 may include one or more connectors to connect to one or more energy storage subsystems 214 external to the portable charging system 202. The portable charging system 202 can be connected to an energy storage subsystem 214 by an energy storage connection port. The energy storage subsystem 214 may be useful to store energy during low demand times on the medium voltage network 204. The stored energy can be used for peak shaving during times of excessive fees from the utility due to high demand from peak draws of power.

The portable charging system 202 includes a triple active bridge (TAB) converter circuit 212. The TAB converter circuit 212 is a three-port converter that utilizes a high frequency (HF) solid-state transformer (SST) for voltage step down and isolation between the connection ports. The TAB converter circuit 212 also includes wide bandgap (WBG) active devices for the power electronics. In some examples, the TAB converter circuit 212 allows the portable charging system 202 to provide a 2 MW output from a 1 MW line input charging feed and a 1 MW output from the energy storage subsystem 214.

The TAB converter circuit 212 is connected to the line connection port and the medium voltage network 204 through an alternating current to direct current (AC-to-DC) converter circuit 216. The TAB converter circuit 212 is connected to the DC side of the AC-to-DC converter circuit 216. The TAB converter circuit 212 can be connected to the charging connection port of the portable charging system 202 by a DC-to-DC converter 218 (e.g., a buck-boost converter) to step-up or step-down the DC voltage to the dispenser unit 210. The TAB converter circuit 212 can be connected to the energy storage subsystem 214 by another DC-to-DC converter 220 to step-up or step-down the DC voltage to the energy storage subsystem 214. This DC-to-DC converter 220 allows the portable charging system to interface to a wide range of energy storage batteries in the energy storage subsystem 214.

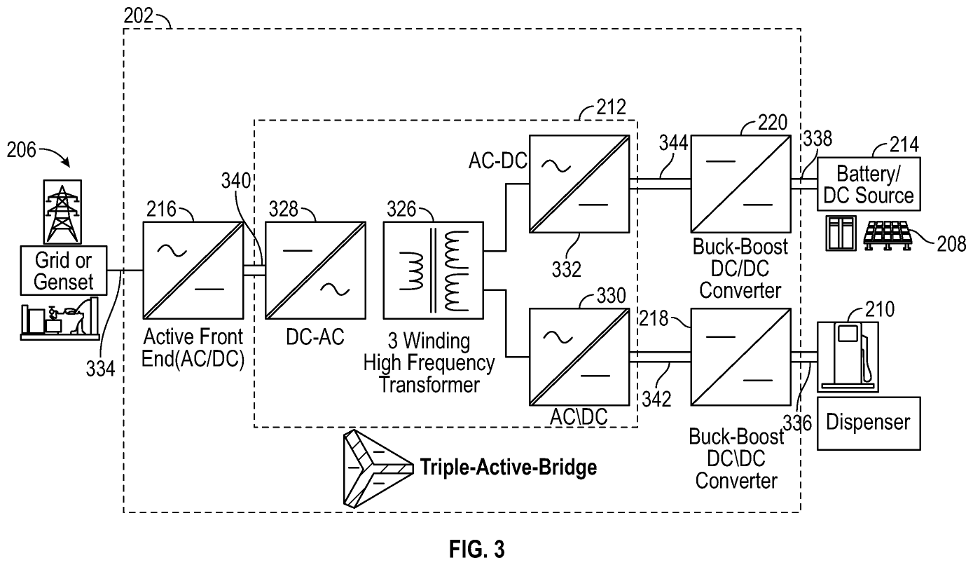

FIG. 3 is another diagram of the portable charging system 202. The diagram of FIG. 3 shows a more detailed diagram of the TAB converter circuit 212. The TAB converter circuit 212 includes three converter circuits 328, 330, 332. The three converter circuits 328, 330, 332, convert between AC and DC. The AC sides of the converter circuits are coupled through a three winding HF transformer 326 leading to a high frequency AC coupling among the converter circuits 328, 330, 332. The DC sides of the converter circuits 328, 330, 332, are coupled to the three ports of the TAB converter circuit 212 including a DC line port 340, a DC charging port 342, and a DC energy storage port 344.

A DC-to-AC converter circuit 328 is arranged between the DC line port 340 of the TAB converter circuit 212 and the three winding HF transformer 326. The DC-to-AC converter circuit 328 is connected to the AC-to-DC converter circuit 216 of the portable charging system 202 and one winding of the three winding HF transformer 326. An AC-to-DC converter circuit 330 is arranged between DC charging port 342 and the three winding HF transformer 326. The AC-to-DC converter circuit 330 is connected to the second winding of the three winding HF transformer 326 and the DC-to-DC converter circuit 218 connected to the dispenser unit 210. Another AC-to-DC converter circuit 332 is arranged between DC energy storage port 344 and the three winding HF transformer 326. The AC-to-DC converter circuit 332 is connected to the third winding of the three winding HF transformer 326 and the DC-to-DC converter circuit 220 connected to the energy storage subsystem 214.

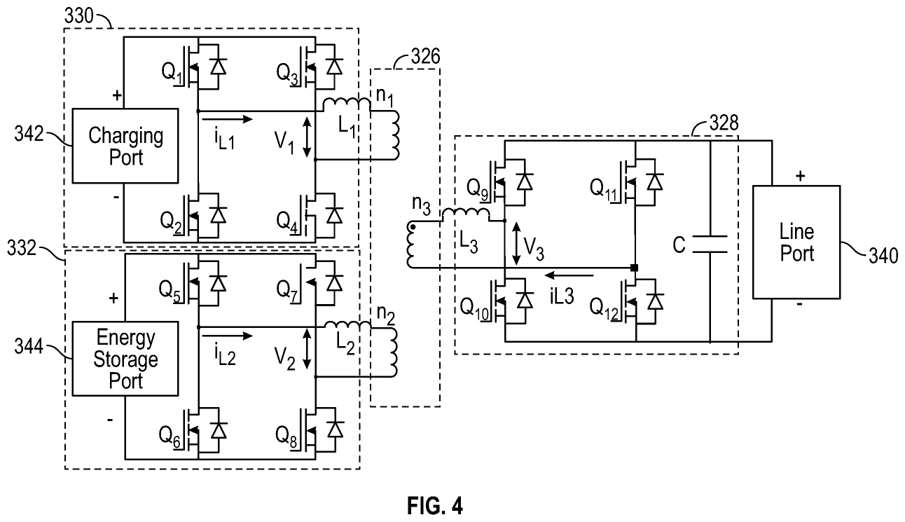

FIG. 4 is a circuit diagram of an example of a TAB converter circuit 212 showing the converter circuits 328, 330, and 332, and the three winding HF transformer 326. The circuit diagram shows the active devices of the converter that includes Field Effect Transistors (FETs) Q1-Q12. The diodes shown in the circuit diagram represent the body diodes of the FETs. The FETs are wide bandgap (WBG) power devices. In some examples, the FETs are silicon carbide FETs.

Returning to FIG. 3, the TAB converter circuit 212 allows the portable charging system 202 to operate in three power-flow states. The first power-flow state is a charging state. Power flows from the line connection port 324 of the portable charging system 202 to the charging connection port 336 of the portable charging system in the first power-flow state. The DC-to-DC converter circuit 220 connected to the energy storage subsystem and the AC-to-DC converter circuit 332 may be bidirectional. Power may also flow from the energy storage connection port 338 in the reverse direction through the DC-to-DC converter circuit 220 and the AC-to-DC converter circuit 332 to the charging connection port 336 to provide charging energy to the work machine from the line connection port 334 and the energy storage subsystem 214. As an illustrative example intended to be non-limiting, the line connection may provide 1 MW of power and the energy storage system may provide 0.5 MW to supply 1.5 MW to the dispenser unit 210. In variations, DC-to-DC converter 220 is connected to a local renewable energy source 208 to provide energy to the dispenser unit 210.

The second power flow state is an energy storage state. Power flows from the line connection port to the energy storage connection port 338 in the second power-flow state. As explained previously herein, the energy storage state can be utilized to store energy during low demand times on the medium voltage network. The stored energy can be used for peak shaving during high demand times when the utility increases their fees due to a peak in demand. Additionally, a portion of the energy received via the line connection may be provided to the dispenser unit 210 and another portion of the energy from the line connection can be used for charging the energy storage system.

The third power-flow state is a grid support state. The DC-to-AC converter circuit 328 and the AC-to-DC converter circuit 216 connected to the line connection port may be bidirectional and the AC-to-DC converter circuit 332 and the DC-to-DC converter circuit 220 connected to the energy storage subsystem may be bidirectional. Power flows from the energy storage connection port 338 in the reverse direction through the converters and HF transformer 326 to the line connection port 334 in the third power-flow state. Thus, the energy storage subsystem 214 (and/or renewable energy source 208) can provide grid support to the medium voltage network 204 and the rest of the job site. This can reduce demand of the job site on the utility grid. In another example, the DC-to-DC converter circuit 218 connected to the dispenser unit 210 and the AC-to-DC converter circuit 330 may be bidirectional to allow for vehicle to grid energy sourcing applications.

The portable charging system 202 is a compact solution due to the TAB based solid state transformer (SST). The TAB converter approach eliminates the need of additional transformers for the grid interconnection and the energy storage systems and meets the isolation requirements for the system with the HF three-winding transformer. The HF SST and WBG power electronics improve fault tolerance for the portable charging system and provide bidirectional power flow for grid support capability. The energy storage subsystem can be integrated into the portable charging system for improved portability.

### INDUSTRIAL APPLICABILITY

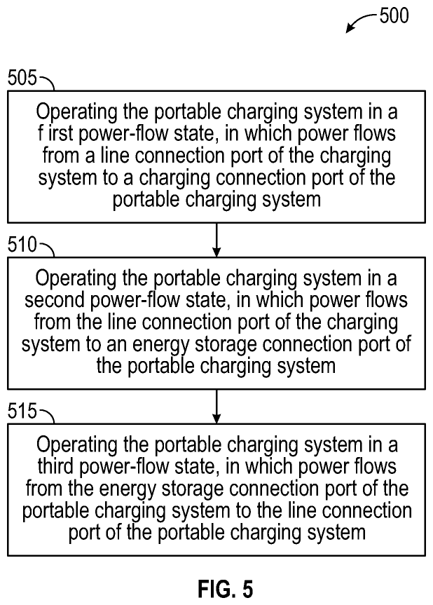

FIG. 5 is a flow diagram of an example of a method 500 of operating a portable charging system for a non-road electric work machine. The method may be performed using the portable charging system 202 of FIG. 2 and FIG. 3. The portable charging system has three ports including a line connection port, a charging connection port, and an energy storage connection port. The portable charging system can be operated in three power-flow states between the three ports of the charging system.

At block 505, the portable charging system is operated in a first power-flow state. Power flows from the line connection port of the portable charging system to the charging connection port of the portable charging system in the first power-flow state. The line connection may be to a medium voltage network or may be to an electric utility grid. The charging connection port is used to provide energy to charge the electric work machine. The first power-flow state may also include power flowing from an energy storage subsystem connected to the energy storage connection port to the charging connection port. In this way, the charge energy provided to the electric work machine can be higher than what is available at the line connection. For example, if 1 MW of power is available from the medium voltage network and another 1 MW of power is available from the energy storage subsystem, 2 MW of charge can be provided to the electric work machine. This reduces or eliminates the need for a full capacity charge source. The energy storage subsystem can be integrated into the portable charging system for a compact portable system.

The portable charging system includes a TAB converter that includes a three-winding HF transformer that provides isolation between the line connection port, the charging connection port, and the energy storage connection port. The TAB converter also includes converters to convert power between AC and DC at the line side, the charger side, and the energy storage side. A DC-to-DC buck-boost converter can be included between the AC-to-DC converter of the energy storage side to provide an interface compatible with a large range of energy storage batteries.

At block 510, the portable charging system is operated in a second power-flow state. Power flows from the line connection port of the portable charging system to the energy storage connection port in the power-flow state to replenish the energy storage subsystem. The portable charging system can include distributed energy resources to provide additional methods to charge the energy storage subsystem and reduce the dependency on the line source. The energy storage subsystem and the distributed energy resources can be integrated into the portable charging system.

At block 515, the portable charging system is operated in a third power-flow state. Power flows from the energy storage connection port of the portable charging system to the line connection port in the third power-flow state. One or more of the converters of the TAB converter are bidirectional to allow the power-flow in this direction. DC power is provided from the energy storage subsystem and converted to AC power provided to the line connection to provide grid support to the job site.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B: A, A and B: A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A portable charging system for a non-road electric vehicle, the system comprising:
a line connection port;
a first Alternating Current to Direct Current (AC-to-DC) converter circuit connected to the line connection port, wherein the first AC-to-DC converter circuit is a bidirectional AC-to-DC converter circuit; and
a three-port triple active bridge (TAB) converter circuit including a DC line port coupled to the first AC-to-DC converter circuit, a DC charging port, and a DC energy storage port.

2. The system of claim 1, wherein the TAB converter circuit includes:
a high frequency (HF) transformer having three windings;
a Direct Current to Alternating Current (DC-to-AC) converter arranged between the DC line port and the HF transformer, and coupled to a first winding of the HF transformer;
a second AC-to-DC converter circuit arranged between the DC charging port and the HF transformer, and coupled to a second winding of the HF transformer; and
a third AC-to-DC converter circuit arranged between the DC energy storage port and the HF transformer, and coupled to a third winding of the HF transformer.

3. The system of claim 2, wherein the DC-to-AC converter circuit and the third AC-to-DC converter circuit are bidirectional power converter circuits.

4. The system of claim 3, including a bidirectional DC-to-DC converter circuit coupled to the third AC-to-DC converter circuit and the DC energy storage port.

5. The system of claim 4, including an energy storage subsystem connected to the bidirectional DC-to-DC converter circuit.

6. The system of claim 2, including a DC-to-DC converter circuit coupled to the second AC-to-DC converter circuit and the DC charging port.

7. The system of claim 6, including a megawatt charging station (MCS) coupled to the DC-to-DC converter circuit.

8. The system of claim 2, wherein the DC-to-AC converter and the second and third AC-to-DC converters include wide bandgap active devices.

9. The system of claim 2, wherein the DC-to-AC converter and the second and third AC-to-DC converters include field effect transistors (FETs) that include silicon carbide.

10. A method of operating a portable charging system for a non-road electric work machine, the method comprising:
operating the charging system in a first power-flow state, wherein power flows from a line connection port of the charging system to a charging connection port of the charging system in the first power-flow state;
operating the charging system in a second power-flow state, wherein power flows from the line connection port of the charging system to an energy storage connection port of the charging system in the second power-flow state; and
operating the charging system in a third power-flow state, wherein power flows from the energy storage connection port of the charging system to the line connection port of the charging system in the third power-flow state.

11. The method of claim 10, wherein the operating the charging system in the first power-flow state includes operating the charging system in a power state in which power flows from one or both of the line connection port and the energy storage connection port of the charging system to the charging connection port of the charging system.

12. The method of claim 10, wherein operating the charging system in the first power-flow state includes providing a first charging energy at the charging connection port of the charging system when there is less than the first charging energy at the line connection port.

13. The method of claim 10, wherein the operating the charging system in the first power-flow state includes:
converting Alternating Current (AC) line power to Direct Current (DC) line power using an AC-to-DC converter and providing the DC line power to a first port of a Triple Action Bridge (TAB) converter circuit;
converting the DC line power to an AC signal and converting the AC signal to a first DC signal using the TAB converter circuit; and
providing the first DC signal to the charging connection port.

14. The method of claim 13, wherein the providing the first DC signal to the charging connection port includes providing the first DC signal to the charging connection port and a first DC-to-DC converter circuit connected to a second port of the TAB converter circuit.

15. The method of claim 13, wherein operating the charging system in the second power state includes:
converting the DC line power to the AC signal and converting the AC signal to a second DC signal using the using the TAB converter circuit; and
providing the second DC signal to the energy storage connection port.

16. The method of claim 15, wherein the providing the second DC signal to the charging connection port includes providing the second DC signal to a second DC-to-DC converter circuit connected to a third port of the TAB converter circuit and the energy storage connection port.

17. The method of claim 13, wherein the operating the charging system in the the third power state includes:
receiving DC energy from an energy storage subsystem at a third port of the TAB circuit;
converting the received DC energy to a second AC signal and converting the second AC signal to a second DC signal using the AC-to-DC convert circuit connected to the first port of the TAB converter circuit; and
providing the AC energy to the line connection port of the charging system.

18. The method of claim 17, wherein the receiving DC energy from an energy storage subsystem includes:
applying the DC energy from one or more batteries of the energy storage subsystem to a DC-to-DC converter circuit; and
providing DC energy from the DC-to-DC converter circuit to the third port of the TAB converter circuit.

19. A portable charging system for a non-road electric vehicle, the system comprising:
a line connection port, a charging connection port, and an energy storage connection port;
a bidirectional Alternating Current to Direct Current (AC-to-DC) converter circuit connected to the line connection port;
a three-port triple active bridge (TAB) converter including a first port connected to the bidirectional AC-to-DC converter circuit; and
wherein the TAB converter circuit is configured to:
receive DC energy from the AC-to-DC converter circuit at the first port and provide charging DC energy to the charging connection port of the portable charging system from a second port of the TAB converter circuit;
provide peak shaving DC energy to the energy storage connection port from a third port of the TAB converter circuit; and
transfer stored DC energy from the third port of the TAB converter circuit to the bidirectional AC-to-DC converter circuit connected to the first port of the TAB converter circuit.

20. The system of claim 19, including a bidirectional DC-to-DC converter circuit connected between the third port of the TAB converter circuit and the energy storage subsystem.
